(19) United States
(12) Patent Application Publication
(10) Pub. No.: US 2025/0005161 A1
(43) Pub. Date: Jan. 2, 2025

(54) UPDATE DETAIL VERIFICATION SYSTEM AND UPDATE DETAIL VERIFICATION METHOD

(71) Applicant: HITACHI, LTD., Tokyo (JP)

(72) Inventors: Takashi OGURA, Tokyo (JP); Hiroshi IWASAWA, Tokyo (JP); Daisuke TSUJI, Tokyo (JP)

(21) Appl. No.: 18/709,828

(22) PCT Filed: Oct. 26, 2022
(86) PCT No.: PCT/JP2022/039949

§ 371 Date: May 14, 2024

(30) Foreign Application Priority Data
Dec. 1, 2021 (JP) 2021-195637

(51) Int. Cl. G06F 21/57

(52) U.S. Cl. CPC G06F 21/572; G06F 2221/033

(57) ABSTRACT

An update detail verification system has: an update information input unit to which update information of a control system is inputted; an update information analysis unit that analyzes the update information; a verification information storage unit in which verification information concerning verification to be performed on detail of update is stored; an update and verification detail setting unit that sets detail of update to be executed on the control system and detail of verification to be executed on the update, among the result of analysis and the verification information; an update and verification execution time estimation unit that estimates an execution time required for executing the update and verification; and an execution feasibility determination unit that, by making a comparison between the estimated execution time and a predetermined limited time, determines whether or not the execution of update and verification can be completed within the limited time.

### TECHNICAL FIELD

The present invention relates to a system and a method for verifying contents of update to be executed to the control system. Specifically, the present invention relates to a technique for verifying security or safety.

### BACKGROUND ART

Progress of DX (Digital Transformation) has familiarized the system for executing various types of control operations in such business as manufacturing and logistics in collaboration with different control targets including humans (manned machine). Improvement in the value of the control system such as productivity and efficiency has attracted much attention. Specifically, the improvement is attained by changing/updating control rules and the system configuration based on the site situation and business determination.

Change in the system, or deficiency in the update contents may deteriorate safety as one of essential requirements of the control system. The deficiency may expose the control system to the threat of cyber attacks such as unauthorized access. There has been demanded to verify security or safety with respect to the system change and update so that safety is assured.

Patent Literature 1 discloses technology relating to the method for verifying security or safety with respect to the change/update of the system. Specifically, the verification is made whether update contents are allowable with respect to change in parameters of the computer system from the aspect of security. If the update contents are not allowable, they are re-examined. If the update contents are allowable, update is executed.

### CITATION LIST

### Patent Literature

Patent Literature 1: Japanese Unexamined Patent Application Publication No. 2019-36274

### SUMMARY OF INVENTION

### Technical Problem

The security verification method as disclosed in Patent Literature 1 is limited up to the process for determining the update contents from the aspect of security. When executing the determined update contents, there may cause the problem that the update cannot be completed after a lapse of downtime in the factory, resulting in an obstacle in the work.

It is an object of the present invention to input a time limit allowable for executing update and verification to determine the verification contents of security or safety with respect to the system update, and further to determine contents of update of the system executable within the time limit, and contents of verification with respect to the update contents for assuring security or safety.

### Solution to Problem

In order to solve the problem, the present invention provides an update contents verification system for verifying contents of update executed to a control system. The system includes an update information input section for receiving an input of update information of the control system, an update information analysis section for analyzing the update information, a verification information storage section for storing verification information relating to verification with respect to the update contents, an update/verification contents setting section for setting contents of update executed to the control system, and contents of verification with respect to the update from the analysis results and the verification information, an execution time estimation section for estimating execution time required for executing the update and the verification, and an executability determination section for comparing the estimated execution time with a predetermined time limit to determine whether or not the update and the verification are executable within the time limit.

The present invention includes the method for determining verification contents of security or safety. The present invention further includes a computer program which allows the computer to implement the method for determining the verification contents of security or safety, and the storage medium which stores the computer program.

### Advantageous Effects of Invention

The present invention allows determination of the system update contents to be executable within the time limit with respect to the control system, and the verification contents of security or safety.

Further characteristics relating to the present invention will be clarified by the following description of the specification and attached drawings. The problems, structures, and advantageous effects other than the above mentioned will be clarified by explanations of the embodiment as described below.

### BRIEF DESCRIPTION OF DRAWINGS

FIG. 1 is a functional block diagram illustrating an example of a functional structure of an update contents verification system according to a first example.

FIG. 2 illustrates a system structure of the update contents verification system according to the first to a third examples.

FIG. 3 illustrates an example of a control system to be used for the first to the third examples.

FIG. 4 represents an example of verification levels to be used for the first to the third examples.

FIG. 5 is an example of a flowchart of an update contents verification method according to the first example.

FIG. 6 is a functional block diagram illustrating an example of a functional structure of an update contents verification system according to a second example.

FIG. 7 is an example of a flowchart of an update contents verification method according to the second example.

FIG. 8 is a functional block diagram illustrating an example of a functional structure of an update contents verification system according to the third example.

FIG. 9 is an example of a flowchart of an update contents verification method according to the third example.

### DESCRIPTION OF EMBODIMENTS

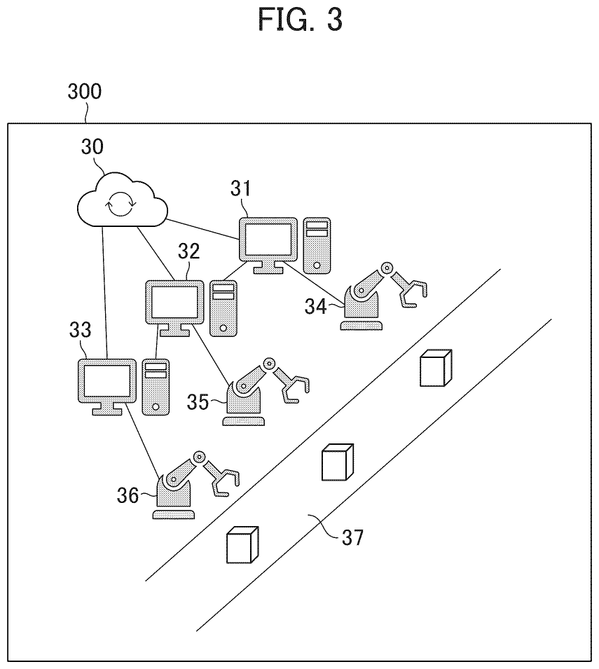

Each example of the present invention is explained referring to the drawings. The respective examples generate update contents of the control system having components as illustrated in FIG. 3, connected with one another, and verification contents of security or safety. The component includes a robot management device A31 and the like. Specific system structure is described later. In the following description, the “update contents of the control system” is simply referred to as “update contents”, and the “verification contents of security or safety” is simply referred to as “verification contents”.

### First Example

A first example of the present invention is described referring to the drawings.

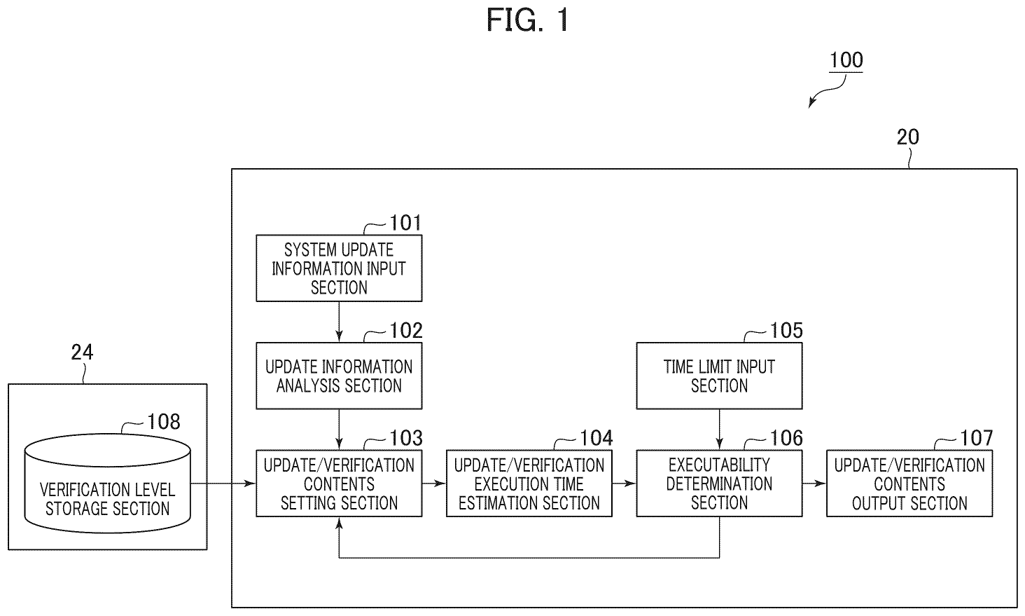

FIG. 1 is a functional block diagram illustrating a functional structure of an update contents verification system 100 according to the example. Each block (function) is described hereinafter.

The update contents verification system 100 includes an update contents verification device 20, and a storage device 24 which is connected to the update contents verification device 20, and stores a verification level storage section 108. The update contents verification device 20 includes a system update information input section 101, an update information analysis section 102, an update/verification contents setting section 103, an update/verification execution time estimation section 104, a time limit input section 105, an executability determination section 106, and an update/verification contents output section 107. The storage device 24 is communicably connected to the update/verification contents setting section 103.

The system update information input section 101 receives an input of update information of the control system. The update information analysis section 102 analyzes the information input from the system update information input section 101, and divides the update information for multiple gradual update processes. The update/verification contents setting section 103 sets one of the gradual update processes derived from the update information analysis section 102 as update contents, and sets the verification contents with respect to the update contents based on the information of the verification level storage section 108. The update/verification execution time estimation section 104 estimates the time required to execute the update/verification contents set by the update/verification contents setting section 103. The time required to execute the update/verification contents refers to the time from start to the end of actual execution of the update and/or verification. It is possible to determine with respect to the start/end of the time automatically, or by an operator. The executability determination section 106 determines whether or not the lapse of time estimated by the update/verification execution time estimation section 104 is within the time limit input in the time limit input section 105, which is an allowable value for executing the update and verification.

The update/verification contents output section 107 outputs and displays the update/verification contents determined to be executable within the time limit by the executability determination section 106. Each of the storage sections and arithmetic sections may be in the form of a CPU, or a PC itself. If the executability determination section 106 determines that the update and verification are not executable within the time limit, the update/verification contents setting section 103 sets different update/verification contents again.

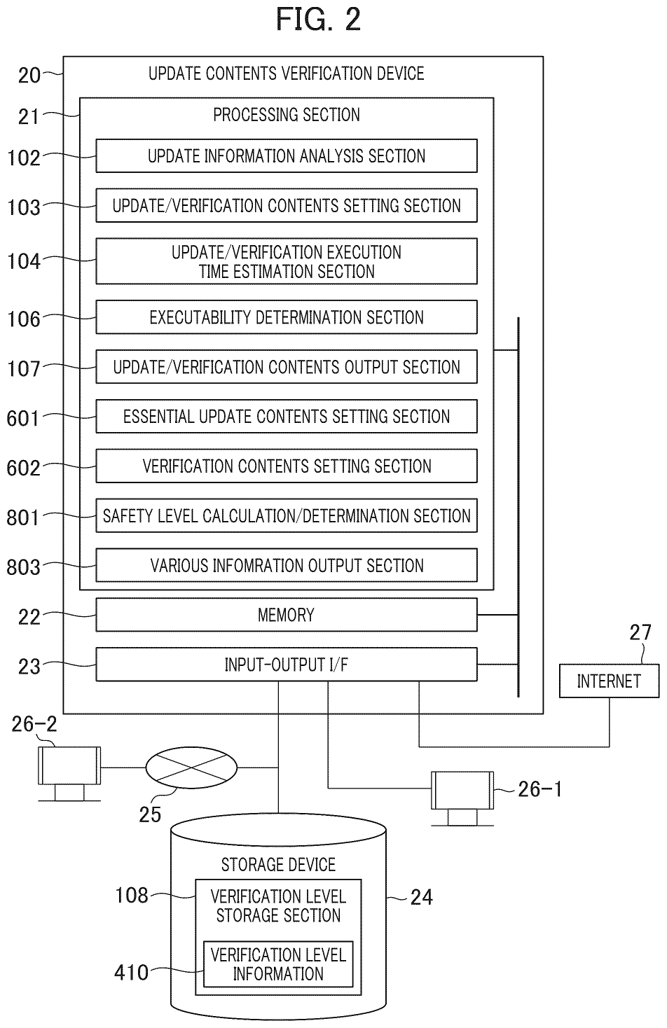

FIG. 2 shows a system structure formed by implementing the functional structure of the update contents verification device 20 as illustrated in FIG. 1 on the computer. The update contents verification device 20 includes a processing section 21, a memory 22, and an input-output I/F 23, which are mutually bus connected to one another like the CPU.

The processing section 21 includes the update information analysis section 102, the update/verification contents setting section 103, the update/verification execution time estimation section 104, the executability determination section 106, the update/verification contents output section 107, an essential update contents setting section 601, a verification contents setting section 602, a safety level calculation/determination section 801, and a various information output section 803, all of which can be implemented by the program. In the example, the program is developed in the memory 22 to allow the processing section 21 to execute the respective functions and arithmetic operations.

The update contents verification device 20 is connected to the storage device 24 via the input-output I/F 23. The storage device 24 stores verification level information 410. That is, the storage device 24 functions as the verification level storage section 108 as illustrated in FIG. 1. The storage device 24 may be installed in the update contents verification device 20.

The essential update contents setting section 601 and the verification contents setting section 602 are not necessarily used in this example, but used in a second example. The safety level calculation/determination section 801 and the various information output section 803 are not necessarily used in this example, but used in a third example.

The update contents verification device 20 is connected to terminal devices 26-1, 26-2 via the input-output I/F 23. The terminal devices 26-1, 26-2 to be implemented by the computer have functions for receiving inputs from the user, and displaying the processing results of the update contents verification device 20.

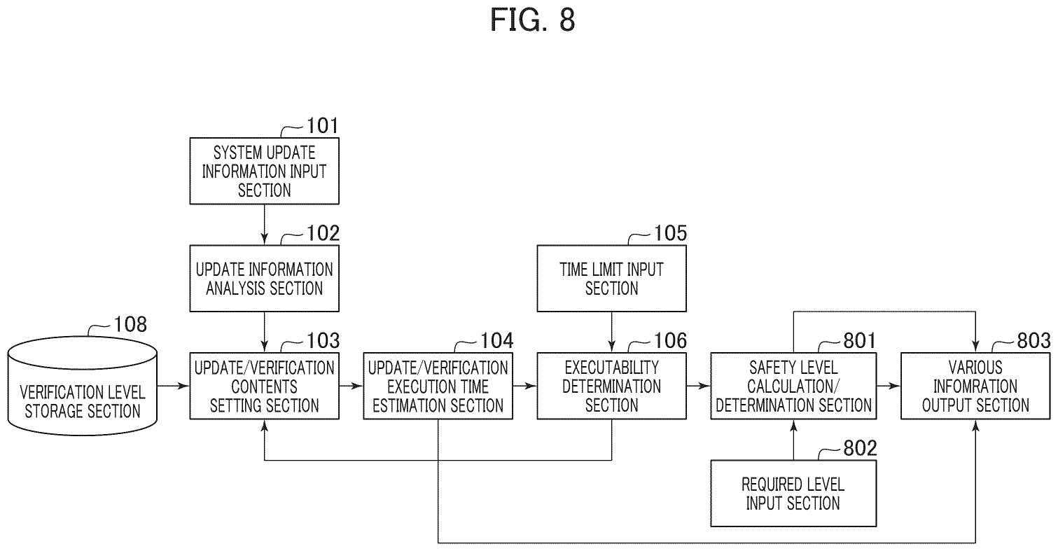

Each of the terminal devices 26-1, 26-2 functions as an input section. More specifically, the terminal devices function as the system update information input section 101 and the time limit input section 105 as shown in FIG. 1, and a required level input section 802 as shown in FIG. 8. The terminal device 26-2 is connected to the update contents verification device 20 via a network 25. The terminal devices 26-1, 26-2 may be integrated with the update contents verification device 20.

In other words, the update contents verification device 20 may be provided with a display device and an input-output device. If the display device or the input-output device is constituted as a component of the system, the function of the update contents verification device 20 is imparted to a cloud 30, and robot management devices A31, B32, C33.

The update contents verification device 20 is connected to the internet 27 so that external information can be acquired. For example, the system to be verified is connected via the internet 27 to allow reception of the verification level information 410 from the system.

The update contents verification method of the example is described in a specific manner. FIG. 3 illustrates a control system as an update target. A control system 300 is constituted by components including the cloud 30, the robot management devices A31, B32, C33, robots A34, B35, C36, and a belt conveyor 37.

The respective components are connected to other components as described below. The cloud 30 is connected to the robot management devices A31, B32, C33. The robot management device A31 is connected to the cloud 30, the robot management device B32, and the robot A34. The robot management device B32 is connected to the cloud 30, the robot management devices A31, C33, and the robot B35. The robot management device C33 is connected to the cloud 30, the robot management device B32, and the robot C36.

The update contents verification device 20 may be connected to the system, or implemented as a component of the system. If the update contents verification device 20 is constituted as a component of the system, the function of the update contents verification device 20 is imparted to the cloud 30, and the robot management device A31, B32, or C33.

The present invention is effective not only for the control system as an example shown in FIG. 3, but also for the control system which allows gradual system updating. For example, the control system which allows the gradual system updating includes a manufacturing line system as shown in FIG. 3, a sorting system in a distribution warehouse, a large-scaled FA (Factory Automation) or PA (Plant Automation) system. The present invention, however, is not limited to the above-described control systems.

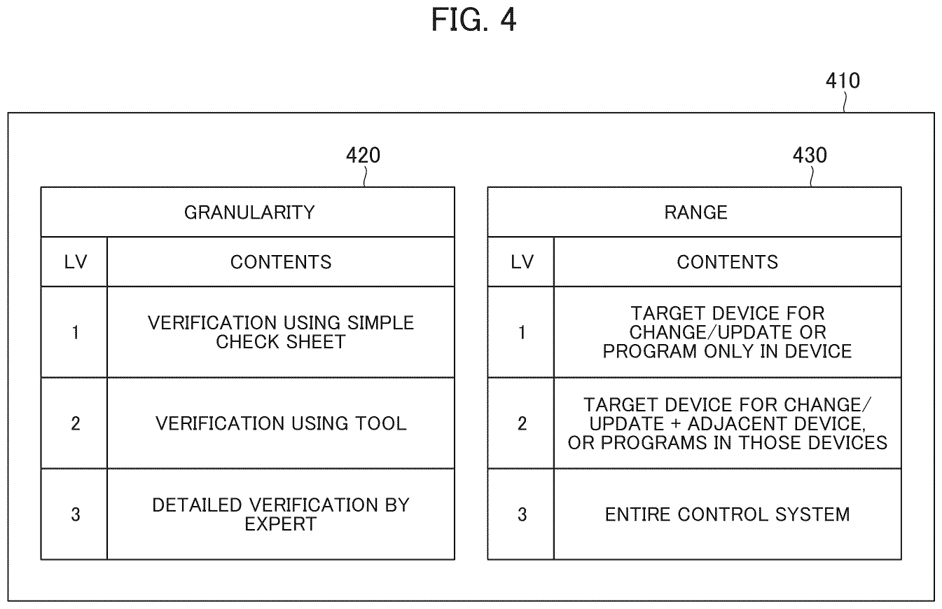

FIG. 4 is a view representing the verification level information 410 stored in the verification level storage section 108. The verification level information 410 includes a granularity table 420 and a range table 430. This example describes the security-related information. There are three levels (Lv) in each table as described below.

### “Granularity” Table 420

Lv1: Verification using simple check sheet
Lv2: Verification using tool
Lv3: Verification by an expert at a granular level

### “Range” Table 430

Lv1: Only target device for change/update
Lv2: Only target device for change/update+adjacent device
Lv3: Entire control system

Concerning the granularity, as the level Lv becomes higher, the verification contents become more granular, requiring more time for verification. Concerning the range, as the level Lv becomes higher, the verification range becomes wider, requiring more time for verification. The verification contents setting section selects each level Lv from the granularity table 420 and the range table 430 so that the selected levels are used for the update/verification contents setting section 103. In this example, the verification level is expressed based on two conditions of granularity and range. The verification contents are determined by selecting the respective levels. The verification level may also be set based on either the granularity or the range. The contents for expressing the verification level do not have to be limited to the granularity and the range. The verification level does not have to be expressed in the table form.

The contents of the granularity table 420 and the range table 430 represent general expressions rather than reflecting structures of the target control system and the like. The verification level may be expressed using the name of the specific device or the network considering the structure of the target control system and the like.

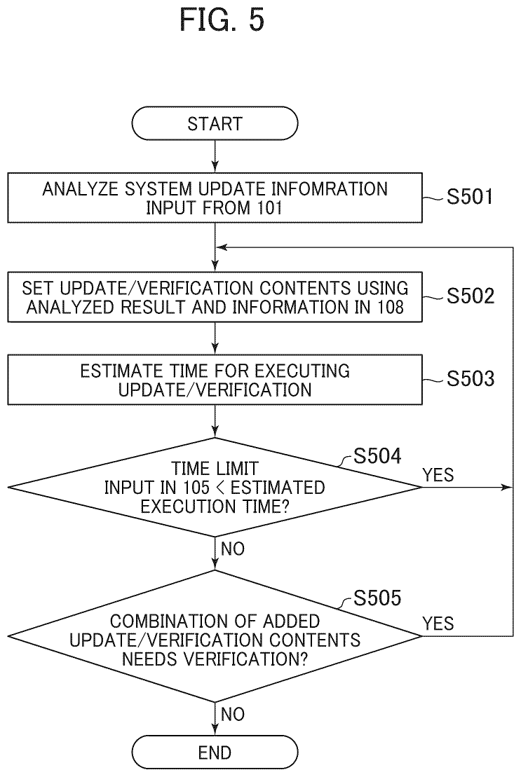

FIG. 5 represents an entire flow of the update contents verification method according to an example of the present invention. The system update information input from the system update information input section 101 is analyzed (S501). The update contents and the verification contents are set using the results analyzed in step S501 and the information stored in the verification level storage section 108 (S502).

The time for executing the set update/verification contents is estimated (S503). The time limit input in the time limit input section 105 is compared with the time for executing the update/verification contents, which has been estimated in step S503 (S504). In step S504, if the time limit is shorter than the estimated execution time, the process returns to step S502 for re-setting of the update/verification contents. Meanwhile, in step S504, if the time limit is equal to or longer than the estimated execution time, the process proceeds to step S505. In step S505, it is determined whether a further combination of the update/verification contents needs verification. In step S505, if it is determined that the further verification is necessary, the process returns to step S502 for re-setting of the update/verification contents. If it is determined that no further verification is necessary, the verification ends.

The respective steps of the flow in FIG. 5 are described with reference to the control system 300 shown in FIG. 3, and the verification level information 410 as an example. It is assumed that the system update information input section 101 receives an input of “update of the robot control programs of the robot management devices A31 and B32, and those devices themselves”. In this example, a text is input in the system update information input section 101. The user is allowed to graphically input the update information on the system structure diagram displayed on the respective screens of the terminal devices 26-1, 26-2, or select any of the update information candidates on the respective screens of the terminal devices 26-1, 26-2. The update information, however, may be arbitrarily input without being limited to the above-described method. In step S501, the input received from the system update information input section 101 is analyzed as described below, and is divided for gradual updating.
1. Update of the robot control program of the robot management device A31.
2. Update of each of the robot control programs of the robot management devices A31 and B32.
3. Update of the robot control program of the robot management device A31, and the device itself.
4. Update of each of the robot control programs of the robot management devices A31 and B32, and the devices themselves.

In step S502 of FIG. 5, the update/verification contents are set using the above-described information and the verification level information 410 as shown in FIG. 4. In this case, the update which takes the longest time is set from the results analyzed in step S501, specifically, “4. update of each of the robot control programs of the robot management devices A31 and B32, and the devices themselves”. The verification level information 410 is set at the highest level Lv3 with respect to both the granularity and the range, that is, “granularity: verification by an expert at a granular level, and “range: entire control system”.

In this example, “update of each of the robot control programs of the robot management devices A31 and B32, and the devices themselves is verified by an expert at a granular level for entire control system”. Those settings can be performed using a digital model (digital twin) having characteristics of hardware or software of the control system as shown in FIG. 3 reproduced in the virtual space. The digital model can be used in the subsequent steps S503 and S504. The present invention is not limited to the use of the digital model for executing steps S502, S503, S504, but applicable to the use of the information having characteristics of hardware or software of the control system expressed by texts in the table form, or by numerical expressions.

In step S503, estimation is made with respect to the time required for executing “update of each of the robot control programs of the robot management devices A31 and B32, and the devices themselves is verified by an expert at a granular level for entire control system”, which has been set in step S502. In this case, it is assumed that the required time is estimated to be six hours.

In the next step S504, the time limit input in the time limit input section 105 is compared with the time estimated in step S503. An explanation is made with respect to the process to be executed when the input time limit is two hours which is shorter than the estimated time of six hours. As the time limit is shorter than the estimated time, the process returns to step S502 for re-setting of the update/verification contents. Re-setting is performed by setting the contents expected to take the second longest execution time next to the currently set update/verification contents.

In the case of this example, the currently set contents include “4. update of each of the robot control programs of the robot management devices A31 and B32, and the devices themselves”, and the highest verification level Lv3 with respect to both the granularity and the range, that is, “granularity: verification by an expert at a granular level”, and “range: entire control system”. Then the contents expected to take the next longest execution time for updating include “3. update of the robot control program of the robot management device A31, and the device itself”, and the highest verification level Lv3 with respect to both the granularity and the range, that is, “granularity: verification by an expert at a granular level”, and “range: entire control system”.

Subsequent to the above-described re-setting, the update/verification execution time is estimated in step S503 in the same manner as described above. Then in step S504, the time limit is compared with the estimated execution time.

This method allows ordering of update contents and update verification contents as candidates in accordance with the greatest updating effect and the contents at the highest verification level. This makes it possible to have determined contents necessarily containing those with the greatest updating effectiveness within the time limit at the highest verification level. The present invention may be applied to the method for randomly setting the respective contents without being limited to the setting method as described above.

Meanwhile, an explanation is made with respect to the process to be executed when the input time limit is 12 hours which is longer than the estimated execution time of six hours. If the time limit is longer than the estimated time, the current update/verification contents are allowable. The process then proceeds to the next step S505. In step S505, it is determined whether it is necessary to verify the additional combination of update/verification contents.

When the user demands an output of multiple combinations of update/verification contents, the process returns to step S502 again to hold the current combination of the update/verification contents, and set the combination different from the current combination of the update/verification contents. The subsequent process is executed in the same manner as described above.

Assuming that the current update is in the condition that “1. update of the robot control program of the robot management device A31, and the device itself” at the highest verification level Lv3 with respect to both the granularity and the range, that is, “granularity: verification by an expert at a granular level”, and “range: entire control system”, the following condition is supposed to be selected as the additional combination of update/verification contents, that is, “1′. update of the robot control program of the robot management device B32, and the device itself” at the highest verification level Lv3 with respect to both the granularity and the range, that is, “granularity: verification by an expert at a granular level”, and “range: entire control system”.

Upon the needs of examining the additional combination, the user may be asked for confirmation every time when executing step S505, or for confirmation before starting the entire process flow. It is also possible to output the single or multiple contents as the default setting for the entire process flow. Meanwhile, if it is determined that the additional combination of update/verification contents is not necessary in step S505, the entire process flow as shown in FIG. 5 ends.

This is the end of the explanation of the example. The example describes the method for verifying the update contents selected from multiple update processes including any one of multiple control programs/devices so that the update contents executed to the control system 300 as shown in FIG. 3 become executable within the time limit. The method for verifying the update contents of the example allows determination with respect to the system update executable within the time limit, and further allows verification of security or safety.

### Second Example

A second example according to the present invention is described referring to the drawings.

Upon examination on the system update, there may be contents which need updating indispensably in the current update process to be executed. In the example of the control system 300 as shown in FIG. 3, the contents which indispensably need update include the process for coping with the failure of the robots A34, B35, C36, and such equipment as the belt conveyor 37, and the process for updating the respective robot control programs of the robot management devices A31, B32, C33 adapted to the change in the target to be processed by the control system. This example describes the system updating method derived from adding the function for setting essential update contents to the method as described in the first example while assuring security or safety of the control system within the time limit.

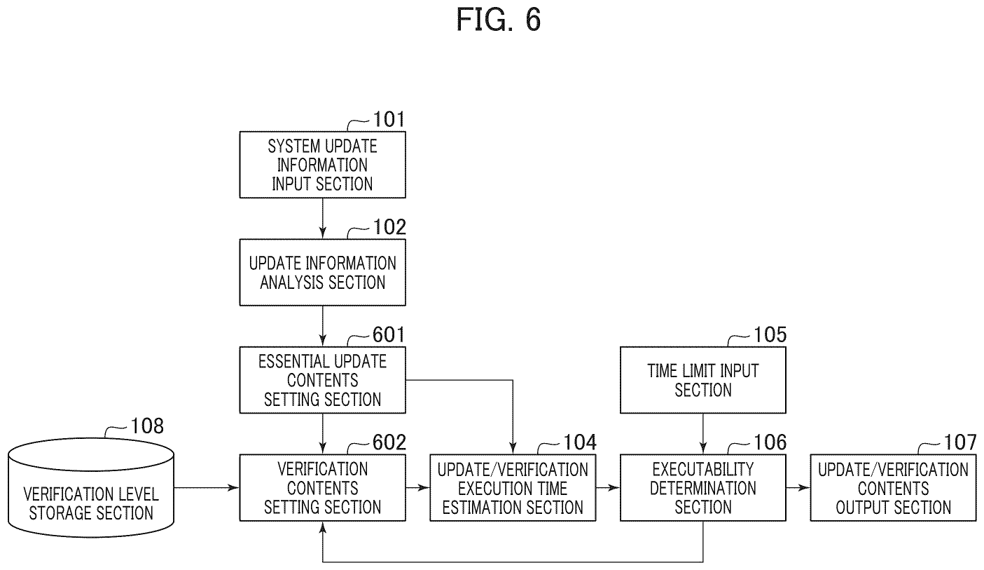

Referring to the block diagram of FIG. 6, in this example, an essential update contents setting section 601 is added to the functional block diagram representing the functional structure of the update contents verification device as described in the first example with reference to FIG. 1, and the update/verification contents setting section 103 is replaced with the verification contents setting section 602. Referring to FIG. 6, reference signs 101, 102, and 104 to 108 are the same as those shown in FIG. 1, and explanations thereof, thus, are omitted. This example further provides the essential update contents setting section 601 and the verification contents setting section 602 as shown in FIG. 2.

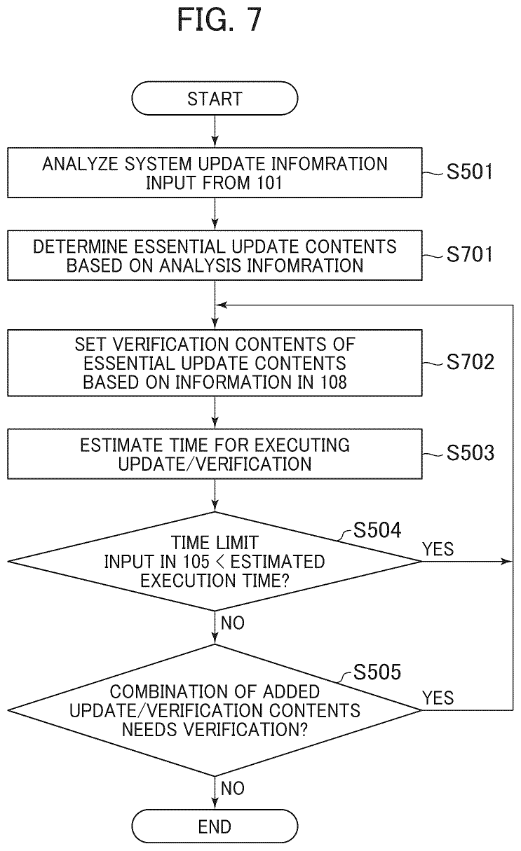

FIG. 7 is a view representing an entire flow of the example. This flow is derived from adding step S701 for determining the essential update contents based on the analyzed information, and step S702 for setting the verification contents with respect to the essential update contents to the entire flow as described in the first example referring to FIG. 5. Referring to FIG. 7, steps S501, S503 to S505 are the same as those described in the first example, and explanations thereof, thus, are omitted. In the following description, an example of the entire flow operation using the control system 300 as shown in FIG. 3 and the verification level information 410 is described in the same manner as the first example.

It is assumed that the system update information input section 101 receives an input of “update of each of the robot control programs of the robot management devices A31 and B32, and those devices themselves”. In this example, a text is input to the system update information input section 101. The user is allowed to graphically input the update information on the system structure diagram displayed on the respective screens of the terminal devices 26-1, 26-2, or select any one of the update information candidates on the respective screens of the terminal devices 26-1, 26-2. The method, however, is not limited to those described above. In step S501, the received input from the system update information input section 101 is analyzed as described below, and is divided for gradual updating.
1. Update of the robot control program of the robot management device A31
2. Update of each of the robot control programs of the robot management devices A31 and B32
3. Update of the robot control program of the robot management device A31, and the device itself
4. Update of each of the robot control programs of the robot management devices A31 and B32, and the devices themselves

In step S701, it is assumed that “3. update of the robot control program of the robot management device A31, and the device itself” is determined as the essential update contents from the above information. The determination may be made by executing machine learning or using AI based on the information input from the system update information input section 101. Alternatively, the user is allowed to execute designation and determination from the terminal devices 26-1, 26-2 when executing step S701. The determination may also be made by inputting only the update contents as the essential update contents when inputting the information in the system update information input section 101.

As the update contents have been already determined in step S701, the verification contents are only determined in step S702. The verification level information 410 is set at the highest level Lv3 with respect to both the granularity and the range, that is, “granularity: verification by an expert at a granular level”, and “range: entire control system”. In this example, the verification contents are set as “update of the robot control program of the robot management device A31, and the device itself as the essential update contents, and verification by an expert at a granular level for entire control system”.

Those settings can be performed using a digital model (digital twin) having characteristics of hardware and software and the like of the control system as shown in FIG. 3 reproduced in the virtual space. The digital model can be used in the subsequent steps S503 and S504. The present invention is not limited to the use of the digital model for executing steps S502, S503, S504, but applicable to the use of the information having characteristics of hardware and software and the like of the control system expressed by texts in the table form, or by numerical expressions.

In step S503, estimation is made with respect to the time required for executing “update of the robot control program of the robot management device A31, and the device itself as essential contents, and verification by an expert at a granular level for entire control system” as set in step S502. In this case, it is assumed that the required time is estimated to be four hours.

In the next step S504, the time limit input in the time limit input section 105 is compared with the time estimated in step S503. An explanation is made with respect to the process to be executed when the input time limit is two hours which is shorter than the estimated time of four hours. As the time limit of two hours is shorter than the estimated time, the process returns to step S702 for re-setting of the verification contents. The re-setting is performed by setting the verification contents expected to take the second longest execution time next to the currently set verification contents.

In the case of this example, the verification contents are changed without changing the essential update contents. The verification contents are currently set at the highest level Lv3 with respect to both the granularity and the range, that is, “granularity: verification by an expert at a granular level”, and “range: entire control system”. Then the verification contents expected to take the second longest execution time next to the currently set verification contents are set at the verification level Lv3 with respect to the granularity, that is, “verification by an expert at a granular level”, and at the level Lv2 with respect to the range, that is, “only target device for change/update+adjacent device or program within those devices”. The re-setting is performed as described above, and subsequently, the update/verification execution time is estimated in step S503 in the same manner as described above. Then in step S504, the time limit is compared with the estimated execution time.

The method in this example executes re-setting of the verification contents with respect to the essential update contents by setting the contents expected to take the second longest execution time next to the currently set contents. This method allows the verification contents to be ordered as candidates from the highest verification level. This makes it possible to have determined contents necessarily containing those at the highest verification level within the time limit, resulting in further improved effect of the present invention. The present invention may be applied to the method for randomly setting the respective contents without being limited to the setting method as described above.

An explanation is made with respect to the process to be executed when the input time limit is 12 hours which is longer than the estimated execution time of four hours. When the time limit of 12 hours is longer than the estimated time of four hours, the current update/verification contents are allowable. The process then proceeds to the next step S505. In step S505, it is determined whether it is necessary to verify the additional combination of update/verification contents. When the user demands an output of multiple combinations of update/verification contents, the process returns to step S502 again to hold the current combination of the update/verification contents, and set the combination different from the current combination of the update/verification contents. The subsequent process is executed in the same manner as described above. The method for adding the update/verification contents may be implemented by re-searching for the essential update, selecting the update which is not essential but has higher importance, or selecting the update randomly.

Upon needs of examining the additional combination, the user may be asked for confirmation every time when executing step S505, or for confirmation before starting the entire process flow. It is also possible to output the single or multiple contents as the default setting for the entire process flow. Meanwhile, if it is determined that the additional combination of update/verification contents is not necessary in step S505, the entire process flow as shown in FIG. 5 ends.

This is the end of the explanation of the example. The method for verifying the update contents according to the example allows determination of verification contents of security or safety while ensuring the essential system update, and execution of the update within the time limit.

### Third Example

A third example according to the present invention is described referring to the drawings.

There may be the security or safety level required to be satisfied when examining the system update. In this case, it is necessary to output the update/verification contents which assure the predetermined or higher safety level. This example has functions added to the method as described in the first example, specifically, the function for inputting the required safety level, the function for calculating the safety level to be attained, and the function for determining whether the calculated level satisfies the required level. Furthermore, the function for including the intermediately output estimated time or the like in the output for the entire flow as shown in FIG. 5.

In this example, the safety level calculation/determination section 801, and the required level input section 802 are added to the functional block diagram representing the functional structure of the update contents verification system as described in the first example with reference to FIG. 1. Referring to the block diagram of FIG. 8, the update/verification contents output section 107 is replaced with the various information output section 803.

Referring to FIG. 8, reference signs 101 to 106, and 108 are the same as those shown in FIG. 1. The various information output section 803 outputs a result of estimated time from the update/verification execution time estimation section 104, and the expected safety level calculated by the safety level calculation/determination section 801 together with the update/verification contents. This allows the user to acquire more information data in addition to the update/verification contents. The safety level calculation/determination section 801 and the various information output section 803 are functional sections installed in the update contents verification device 20 as shown in FIG. 2. Referring to FIG. 8, although the safety level calculation/determination section is described as a single functional section, this section may be separated into individual functional sections.

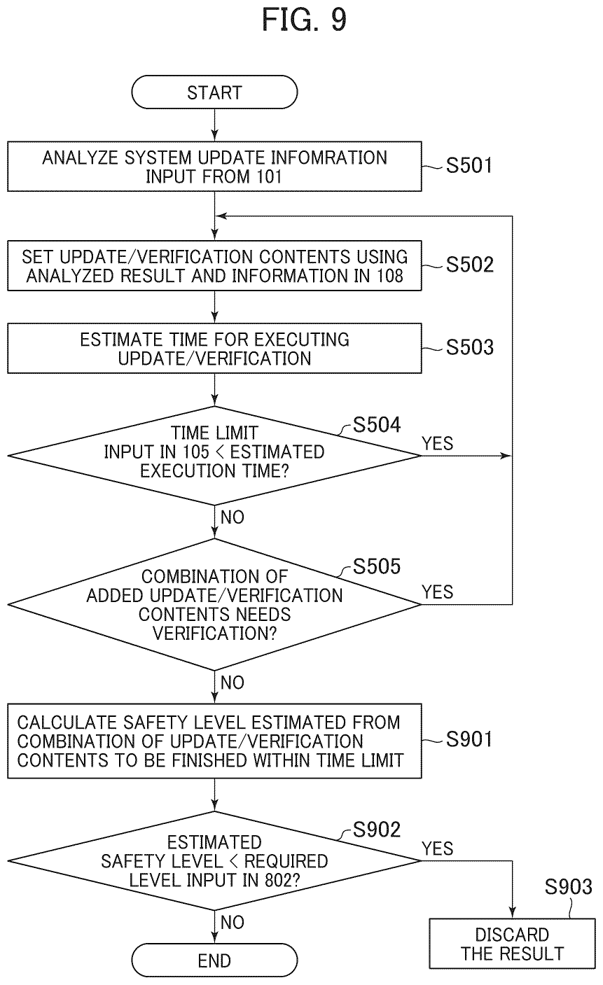

FIG. 9 is a view representing an entire flow of the example. This flow is derived from adding steps S901 and S902 to the entire flow as described in the first example with reference to FIG. 5. Step S901 calculates the safety level expected from the combination of the update/verification contents to be executable within the time limit, and step S902 compares the expected safety level with the required level input in the required level input section 802. Referring to FIG. 9, reference signs S501 to S505 are the same as those described in the first example, and explanations thereof, thus, are omitted. In the following description, an example of the entire flow operation using the control system 300 as shown in FIG. 3 and the verification level information 410 is described in the same manner as the first example.

Steps S501 to S505 in FIG. 9 are the same as those described in the first example. Step S901 calculates the safety level of either security or safety with respect to the respective combinations of the update/verification contents to be executable within the time limit as processed in step S505. The level to be attained may be calculated with reference to such approach as standards. Alternatively, the arithmetic operation may be performed for calculating the level with respect to the level Lv of the verification level information 410.

Step S902 compares the calculated safety level with the required level input in the required level input section 802 to determine whether the calculated safety level satisfies the requirement. If it is determined in step S902 that the combination of the update/verification contents does not satisfy the requirement, the process proceeds to step S903 where the combination of the update/verification contents is discarded without being output. Meanwhile, if it is determined in step S902 that the specific combination of the update/verification contents satisfies the requirement, the combination of the update/verification contents is output. The determination as described above is executed with respect to the combinations of the update/verification contents to be executable within the time limit as determined in step S505.

This is the end of the explanation of the example. The method for determining the verification contents of safety according to the example allows determination with respect to the system update executable within the time limit, and the verification contents of safety while satisfying the required safety level to be attained.

The examples of the present invention as described above provide the following advantageous effects.
(1) The update contents verification system according to the present invention verifies contents of update executed to the control system. The system includes the update information input section for receiving an input of update information of the control system, the update information analysis section for analyzing the update information, the verification information storage section for storing verification information relating to verification with respect to the update contents, the update/verification contents setting section for setting contents of update executed to the control system, and contents of verification with respect to the update from the analysis results and the verification information, the execution time estimation section for estimating execution time required for executing the update and the verification, and the executability determination section for comparing the estimated execution time with a predetermined time limit to determine whether or not the update and the verification are executable within the time limit.

The above structure allows determination with respect to the system update executable within the time limit allowable for the control system, and the safety verification contents.
(2) The update information analysis section analyzes the update information, and divides the update information for multiple updating processes. This makes it possible to generate multiple update processing candidates to be executed to the control system, and to secure more options of update/verification contents to be executed.
(3) The update/verification contents setting section sets at least one of multiple divided updating processes as the update contents to be executed to the control system. This makes it possible to execute part of the update contents even when all update contents included in the update information cannot be executed. It is possible to select the update contents from various aspects.
(4) At least one of the analysis by the update information analysis section, the setting by the update/verification contents setting section, and the estimation by the execution time estimation section is executed based on a digital model derived from reproduction of hardware or software for implementing the control system on a computer. This makes it possible to execute the processing without using hardware and/or software, resulting in saving of resources.
(5) The verification information contains at least one of a verification range and a verification granularity each set at multiple levels. This makes it possible to suitably prioritize the update/verification contents for selection based on the above-described information.
(6) If the executability determination section determines that the update and the verification are executable within the time limit, the update/verification contents setting section additionally sets the update contents and the verification contents other than the execution and the verification contents, which have been determined to be executable within the time limit, the execution time estimation section estimates time required for executing the additionally set update and verification, and the executability determination section determines whether or not it is possible to execute the additionally set update and verification in addition to the update and the verification, which have been determined to be executable within the time limit. This makes it possible to execute the additional update and verification even after executing the single update/verification, resulting in improved safety of the control system.
(7) The update contents verification system further includes an essential update contents setting section for setting essential update contents from results of the analysis by the update information analysis section. This makes it possible to set the essential update contents even in the presence of multiple update processes executable to the control system. This may reduce the risk of exposing the control system to danger as a result of preferential execution of other non-essential updating processes in the presence of the device/program required to be immediately updated from the security aspect, for example.
(8) The update contents verification system further includes a safety level calculation section for calculating a safety level estimated to be attained when executing the update and the verification, which have been determined to be executable within the time limit by the executability determination section, and a safety level determination section for determining whether the update and the verification are executable based on a comparison between the estimated safety level and a safety level required for the control system. This makes it possible to reduce the risk of exposing the control system to danger in the same manner as the advantageous effect (7).
(9) The update contents verification method for verifying contents of update executed to a control system, comprising the steps of acquiring update information of the control system, analyzing the update information, setting contents of update to be executed to the control system, and verification with respect to the update from a result of the analysis and verification information relating to the verification with respect to contents of the update, estimating execution time required for executing the update and the verification, and determining whether or not the update and the verification are executable within a time limit based on a comparison between the estimated execution time and a predetermined time limit.

Similar to the advantageous effect (1), this makes it possible to determine the system update executable within the time limit allowable for the control system, and the safety verification contents.

This is the end of explanations of the embodiments according to the present invention. The present invention is not limited to the embodiments as described above, but includes various modifications. The embodiments have been described in detail for clear understanding of the present invention. The present invention is not necessarily limited to all structures, processes, information data, and numerical values, which have been explained, for example, contents of the information stored in the storage section, the analyzing process executed by the update information analysis section, the estimation processing executed by the update/verification execution time estimation section, output results, and the like.

The respective structures, functions, processing sections, and the processing means may be partially or entirely implemented by hardware through the design process using the integrated circuit, for example. The respective structures, functions, and the like may be implemented by software through the process of interpreting and executing the program for implementing the respective functions. The information including the program, table, file, and the like for implementing the respective functions may be stored in the recording device such as the memory, hard disk, SSD (Solid State Drive), or the recording medium such as the IC card, SD card, and DVD.

### LIST OF REFERENCE SIGNS

101 . . . system update information input section (update information input section)
102 . . . update information analysis section
103 . . . update/verification contents setting section
104 . . . update/verification execution time estimation section
105 . . . time limit input section
106 . . . executability determination section
108 . . . verification level storage section (verification information storage section)
300 . . . control system
410 . . . verification level information
601 . . . essential update contents setting section
801 . . . safety level calculation/determination section (safety level calculation section/safety level determination section)

1. An update contents verification system for verifying contents of update executed to a control system, comprising:
an update information input section for receiving an input of update information of the control system;
an update information analysis section for analyzing the update information;
a verification information storage section for storing verification information relating to verification with respect to the update contents;
an update/verification contents setting section for setting contents of update executed to the control system, and contents of verification with respect to the update from the analysis results and the verification information;
an execution time estimation section for estimating execution time required for executing the update and the verification; and
an executability determination section for comparing the estimated execution time with a predetermined time limit to determine whether or not the update and the verification are executable within the time limit.

2. The update contents verification system according to claim 1,
wherein the update information analysis section analyzes the update information, and divides the update information for multiple updating processes.

3. The update contents verification system according to claim 2,
wherein the update/verification contents setting section sets at least one of multiple divided updating processes as the update contents to be executed to the control system.

4. The update contents verification system according to claim 1,
wherein at least one of the analysis by the update information analysis section, the setting by the update/verification contents setting section, and the estimation by the execution time estimation section is executed based on a digital model derived from reproduction of hardware or software for implementing the control system on a computer.

5. The update contents verification system according to claim 1,
wherein the verification information contains at least one of a verification range and a verification granularity each set at multiple levels.

6. The update contents verification system according to claim 1, wherein:
if the executability determination section determines that the update and the verification are executable within the time limit, the update/verification contents setting section additionally sets the update contents and the verification contents other than the execution and the verification contents, which have been determined to be executable within the time limit;
the execution time estimation section estimates time required for executing the additionally set update and verification; and
the executability determination section determines whether or not it is possible to execute the additionally set update and verification in addition to the update and the verification, which have been determined to be executable within the time limit.

7. The update contents verification system according to claim 1, further comprising
an essential update contents setting section for setting essential update contents from results of the analysis by the update information analysis section.

8. The update contents verification system according to claim 1, further comprising:
a safety level calculation section for calculating a safety level estimated to be attained when executing the update and the verification, which have been determined to be executable within the time limit by the executability determination section; and
a safety level determination section for determining whether the update and the verification are executable based on a comparison between the estimated safety level and a safety level required for the control system.

9. An update contents verification method for verifying contents of update executed to a control system, comprising the steps of:
acquiring update information of the control system;
analyzing the update information;
setting contents of update to be executed to the control system, and verification with respect to the update from a result of the analysis and verification information relating to the verification with respect to contents of the update;
estimating execution time required for executing the update and the verification; and
determining whether or not the update and the verification are executable within a time limit based on a comparison between the estimated execution time and a predetermined time limit.
